(19) United States
(12) Patent Application Publication
(10) Pub. No.: US 2015/0302981 A1
(43) Pub. Date: Oct. 22, 2015

(54) TRANSFORMER

(71) Applicant: FDK CORPORATION, Tokyo (JP)

(72) Inventors: Koji KANEKO, Tokyo (JP); Satoshi OTA, Tokyo (JP)

(21) Appl. No.: 14/378,756

(22) PCT Filed: Dec. 25, 2012
(86) PCT No.: PCT/JP2012/008242

§ 371 Date: Aug. 14, 2014

(30) Foreign Application Priority Data
Feb. 23, 2012 (JP) 2012-037205

(51) Int. Cl. H01F 27/34; H01F 27/24; H01F 27/28

(52) U.S. Cl. CPC H01F 27/346; H01F 27/28; H01F 27/24

(57) ABSTRACT

There is provided a transformer in which leakage inductance can be adjusted arbitrarily and which can be readily processed and achieves reduction in size. The transformer includes: a primary coil (10) and a secondary coil (12); and a core (14) that forms an annular closed magnetic circuit by being arranged across the primary coil and the secondary coil. A magnetic body (15) having a cross-sectional area smaller than a cross-sectional area of the core is arranged between the primary coil (10) and the secondary coil (12) so as to interpose a spacing between both of its end parts and the core and so as to make a short-cut of the annular closed magnetic circuit.

### TECHNICAL FIELD

The present invention relates to a transformer incorporated in a power supply circuit, and specifically, relates to a transformer in which leakage inductance is increased and which achieves reduction in size.

### BACKGROUND ART

From among transformers incorporated in a power supply circuit, a transformer is known in which leakage inductance is increased by positively causing leakage of magnetism transmitted from a primary coil to a secondary coil to be generated.

FIG. 11 illustrates a conventional transformer of this type. A primary coil 2 is obtained by winding on one end part side of a bobbin 1 and a secondary coil 3 is obtained by winding on the other end part thereof. A pair of E-shaped cores 4 in which center legs 4a of them are inserted into the bobbin and outer legs 4b of them are arranged opposite to each other along an outer circumference of the primary coil 2 or the secondary coil 3 form a closed magnetic circuit.

In the transformer with the above-mentioned configuration, in order to increase the leakage inductance, the interlinking state between both coils is necessary to be reduced by increasing a spacing between the primary coil 2 and the secondary coil 3 as illustrated in the figure. This causes a problem of the transformer in itself to be large in dimensions.

On the contrary, FIG. 12 illustrates another conventional transformer shown in Patent Literature 1 below. Leakage inductance can be arbitrarily configured in this transformer in which the primary coil 2 and the secondary coil 3 are arranged such that axis lines of them are parallel to each other, one of the outer legs 4b in each of the pair of E-shaped cores 4 is inserted into the bobbin of the primary coil 2, the other of the outer legs 4b therein is inserted into the bobbin of the secondary coil 3, in this state, the center legs 4a are arranged opposite to each other between outer circumferential parts of the primary coil 2 and the secondary coil 3, and a gap is formed between these center legs 4a to adjust a leakage magnetic circuit.

According to the transformer with the above-mentioned configuration, there is a merit of being smaller in dimensions compared with the one illustrated in FIG. 11 since the gap formed between the center legs 4a of the E-shaped cores 4 allows a leakage magnetic circuit to be adjusted. Nevertheless, the thickness dimension of the center legs 4a still causes the problem of a product to be large in dimensions.

Therefore, as a method to solve the problem, to make only the center legs 4a thin may be expected for the measures. However, primarily, it is difficult for only the center legs 4a to be processed thin. In addition to this, there are concerns that the center legs 4a may suffer breakage in assembling and that the center legs 4a may suffer cracking, for example, caused by vibration or the like at an unexpected portion after usage in a power supply circuit.

### CITATION LIST

### Patent Literature

Patent Literature 1: Japanese Patent Laid-Open No. 05-67536

### SUMMARY OF INVENTION

### Technical Problem

The present invention is devised in view of the above-mentioned circumstances and a problem to be solved is to provide a transformer in which leakage inductance can be arbitrarily adjusted and which can be readily processed and achieve reduction in size.

### Solution to Problem

In order to solve the above-mentioned problem, the invention according to Claim 1 provides a transformer including: a primary coil and a secondary coil; and a core that forms an annular closed magnetic circuit by being arranged across the primary coil and the secondary coil, wherein a magnetic body having a cross-sectional area smaller than a cross-sectional area of the core is arranged between the primary coil and the secondary coil so as to interpose a spacing between both of its end parts and the core and so as to make a short-cut of the annular closed magnetic circuit.

Herein, the invention according to Claim 2 is provided in the invention according to Claim 1, wherein the primary coil and the secondary coil are arranged such that axis lines of them coincide with each other, and the magnetic body is arranged between end faces of the primary coil and the secondary coil.

Furthermore, the invention according to Claim 3 is provided in the invention according to Claim 2, wherein the core is formed into a theta shape and includes a center leg inserted into the primary coil and the secondary coil and a pair of outer legs opposite to each other to interpose the periphery of the primary coil and the secondary coil therebetween, and the magnetic body is arranged between the center leg and the outer legs.

On the other hand, the invention according to Claim 4 is provided in the invention according to Claim 1, wherein the primary coil and the secondary coil are arranged such that axis lines of them are parallel to each other, and the magnetic body is arranged between the axis lines and between outer circumferential parts of the primary coil and the secondary coil.

Furthermore, the invention according to Claim 5 is provided in the invention according to Claim 4, wherein the core is formed into a rectangle shape and includes a first core inserted into the primary coil, a second core inserted into the secondary coil and third cores which are disposed on end face sides of the primary coil and the secondary coil and join end parts of the first and second cores together, and the magnetic body is arranged between the third cores.

Moreover, the invention according to Claim 6 is provided in the invention according to Claim 5, wherein the first and second cores are formed into non-columnar shapes each of which has a long-side part and a short-side part in cross-sectional view perpendicular to the axis line and are arranged such that longitudinal directions of them are parallel to each other, and the third core is formed such that its length dimension in the longitudinal direction is larger than a length dimension of the first and second cores in the relevant longitudinal direction.

### Advantageous Effects of Invention

According to the invention in any of Claims 1 to 6, in addition to the annular primary closed magnetic circuit, of the core, which penetrates the primary coil and the secondary coil, the magnetic body arranged between the primary coil and the secondary coil can further form a magnetic circuit which is a short-cut of the relevant closed magnetic circuit and does not penetrate the primary coil or the secondary coil. By doing so, leakage inductance can be increased.

Moreover, since the magnetic body is separate from the core, its width dimension, thickness dimension, shape, spacing toward the core, and the like can be freely selected. This enabling a leakage inductance amount to be adjusted readily and arbitrarily. Furthermore, there is no concern of cracking unlikely for its integral molding with the core. In addition to this, since its cross-sectional area is smaller than that of the core forming the primary closed magnetic circuit in advance, forming its thickness to be thinner than that of the core enables the entirety of the transformer to be reduced in size and thin in thickness.

Especially, in the invention according to Claims 4 to 6, the primary coil and the secondary coil are arranged such that the axis lines of them are parallel to each other, this affording a merit of the transformer to be thin in thickness. In addition to this, in the invention according to Claim 5, the core forming the primary closed magnetic circuit is formed into a rectangle shape and the magnetic body is arranged between the opposing third cores, this enabling the magnetic body to be a further thinner plate shape.

Moreover, when the core is formed into a rectangle shape, designing is necessary to be same as to the cross-sectional areas in directions perpendicular to directions of interlinking with magnetic flux in the first core, the second core and the third cores. To this end, in the invention according to Claim 6, the first and second cores are formed into non-columnar shapes each of which has a long-side part and a short-side part in cross-sectional view as above and are arranged such that the longitudinal directions of them are parallel to each other, and the third cores are formed such that the length dimension of them in the longitudinal direction is larger than the length dimension in the longitudinal direction of the first and second cores. Hence, the thickness dimension of the third core can be relatively reduced, this attaining to be further thin in thickness.

### BRIEF DESCRIPTION OF DRAWINGS

FIG. 1 is a longitudinal cross-sectional view schematically illustrating a first embodiment of the present invention.

FIG. 2 is a transverse cross-sectional view of a portion in which a magnetic body according to the first embodiment is arranged.

FIG. 3 is a perspective view illustrating the first embodiment as a whole.

FIG. 4 is a transverse cross-sectional view illustrating a modification of the magnetic body in FIG. 2.

FIG. 5 is a transverse cross-sectional view illustrating another modification of the magnetic body in FIG. 2.

FIG. 6A illustrates a modification of the first embodiment and is a transverse cross-sectional view of a portion in which the magnetic body is arranged.

FIG. 6B illustrates the modification of the first embodiment and is a longitudinal cross-sectional view of the essential part thereof.

FIG. 7 is a longitudinal cross-sectional view schematically illustrating a second embodiment of the present invention.

FIG. 8A is a longitudinal cross-sectional view illustrating the second embodiment.

FIG. 8B is an elevation view illustrating the second embodiment.

FIG. 9A is a plan view illustrating a core shape in FIG. 8A and FIG. 8B.

FIG. 9B is an elevation view illustrating the core shape in FIG. 8A and FIG. 8B.

FIG. 10 is a perspective view in longitudinal cross-sectional view of a half portion of the second embodiment.

FIG. 11 is a longitudinal cross-sectional view illustrating a conventional transformer.

FIG. 12 is a longitudinal cross-sectional view illustrating another conventional transformer.

### DESCRIPTION OF EMBODIMENTS

### First Embodiment

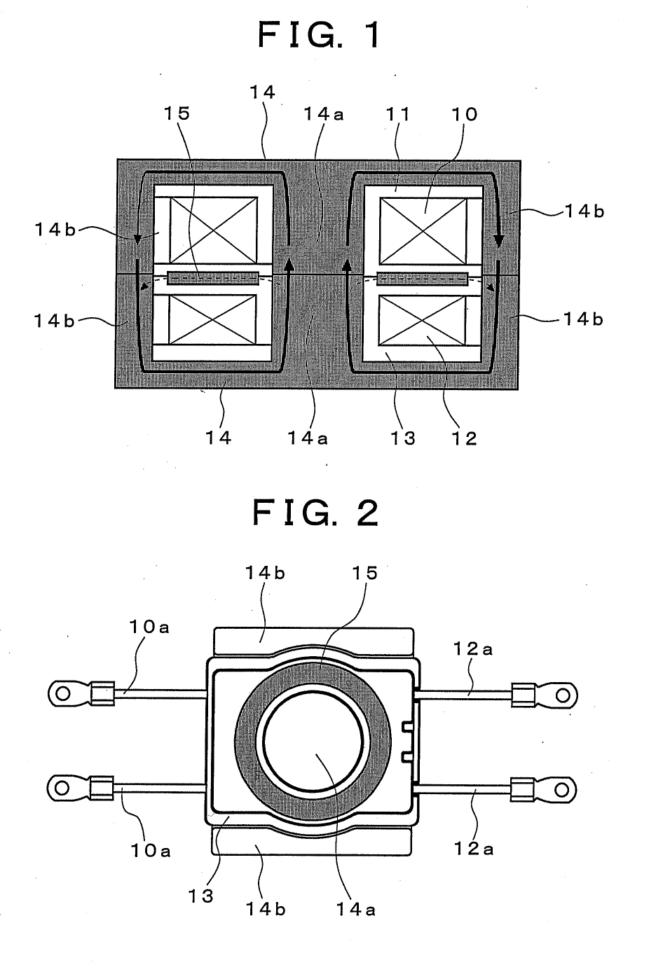

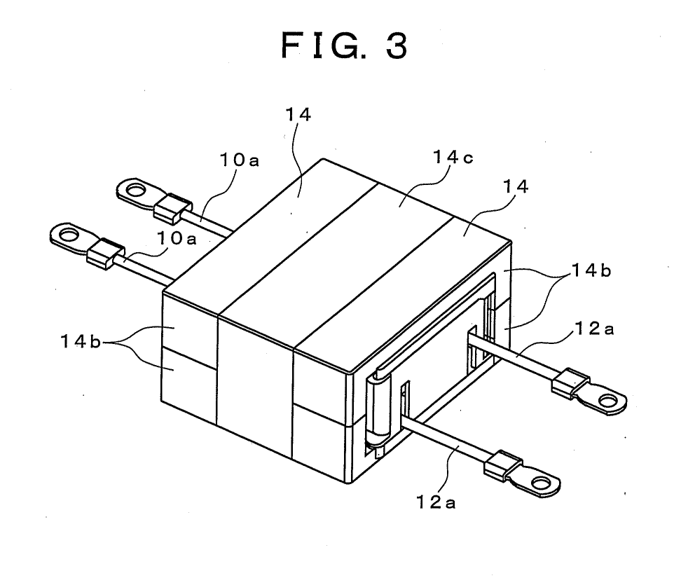

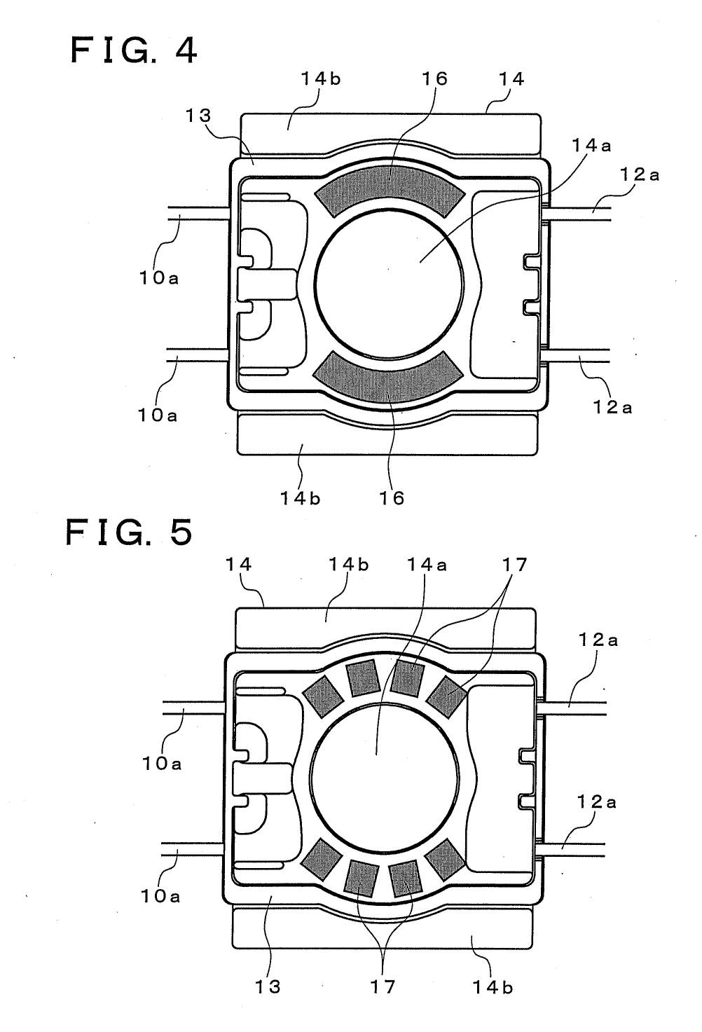

FIG. 1 to FIG. 3 illustrate a first embodiment of a transformer according to the present invention. FIG. 4 to FIG. 6B illustrate individual modifications thereof.

In FIG. 1 to FIG. 3, the sign 10 designates a primary coil obtained by winding around a bobbin 11 and the sign 12 designates a secondary coil obtained by winding around a bobbin 13. The primary coil 10 and the secondary coil 12 are arranged such that their axis lines coincide with each other by stacking end faces of the ring-shaped bobbins 11 and 13. Note that the signs 10a and 12a designate leader lines of the primary coil 10 and the secondary coil 12, respectively.

A core which forms an annular primary closed magnetic circuit represented by the solid arrows in FIG. 1 is arranged across the primary coil 10 and the secondary coil 12.

The core has a pair of E-shaped ferrite cores (hereafter, referred to as E-shaped cores) 14 which are arranged opposite to each other formed into a theta shape. Namely, as to the E-shaped cores 14, in each of them, a columnar center leg 14a is inserted in the primary coil 10 or the secondary coil 12. Two flat plate-shaped outer legs 14b are arranged opposite to each other to interpose the primary coil 10 or the secondary coil 12 therebetween. Tips of the center legs 14a and tips of the outer legs 14b come into contact with the corresponding counterparts. They are integrally shaped by winding an adhesive tape 14c thereon.

A magnetic plate (magnetic body) 15 made of ferrite is attached between opposite faces of the bobbins 11 and 13 of the primary coil 10 and the secondary coil 12. The magnetic plate 15 is formed to be ring-shaped and thin in plate thickness. It surrounds the center leg 14a of the core to interpose a spacing therebetween and is accommodated in ring-shaped recesses formed on the opposite faces of the bobbins 11 and 13 also to interpose a spacing between its outer circumferential edge and the outer legs 14b.

By doing so, the magnetic plate 15 is arranged to make a short-cut, as represented by the dotted arrows in FIG. 1, of the annular primary closed magnetic circuit which is formed by the core and penetrates the primary coil 10 and the secondary coil 12. Moreover, the magnetic plate 15 is formed such that a cross-sectional area (interlinking area) perpendicular to a direction of interlinking with its magnetic flux is smaller than a cross-sectional area (interlinking area) perpendicular to a direction of interlinking with magnetic flux of the E-shaped core 14 in the center leg 14a or the outer leg 14b thereof.

According to the transformer of the first embodiment with the above-mentioned configuration, in addition to the annular primary closed magnetic circuit which is formed in the core and penetrates the primary coil 10 and the secondary coil 12, the magnetic plate 15 arranged between the primary coil 10 and the secondary coil can further form a magnetic circuit which is a short-cut of the relevant closed magnetic circuit and does not penetrate the primary coil 10 or the secondary coil 12. By doing so, leakage inductance can be increased.

Moreover, since the magnetic plate 15 is separate from the E-shaped core 14, its width dimension, thickness dimension, shape, spacing toward the core, and the like can be freely selected, this enabling a leakage inductance amount to be adjusted readily and arbitrarily. Structural restriction, for example, in leader portions for the leader lines 10a and 12a of the primary coil 10 and the secondary coil 12, if any, can be handled by an arrangement of two magnetic plates 16 obtained by division into arc plate shapes or an arrangement of eight magnetic plates 17 obtained by further division of these as illustrated in FIG. 4 or FIG. 5.

Moreover, since any of the magnetic plates 15, 16 and 17 is separate from the E-shaped core 14, there is no concern of its breakage in production or after the production, unlikely for integral molding with the E-shaped core 14. In addition to this, since the E-shaped core 14 allows the cross-sectional area to be small, forming the thickness dimension to be thinner than that of the E-shaped core 14 enables the entirety of the transformer to be reduced in size and thin in thickness.

Note that in any of the first embodiment and the modifications of the magnetic plate 15 therein, there is described the case where the bobbin 11 for the winding of the primary coil 10 and the bobbin 13 for the winding of the secondary coil 12 are formed to be separate from each other and the magnetic plates 15, 16 or 17 are placed in the recesses formed on the opposite faces. But the present invention is not limited to these, being able to be implemented as various modifications.

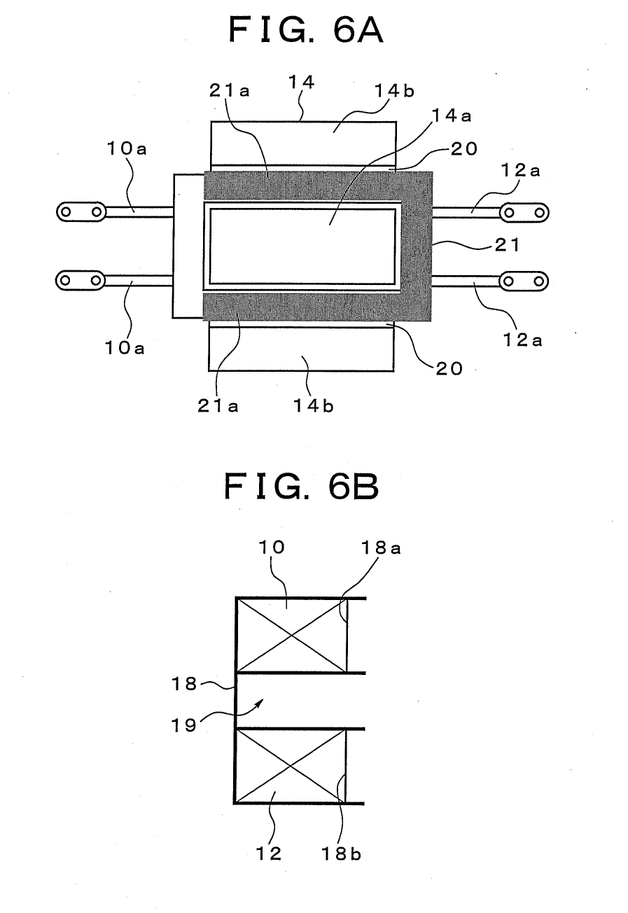

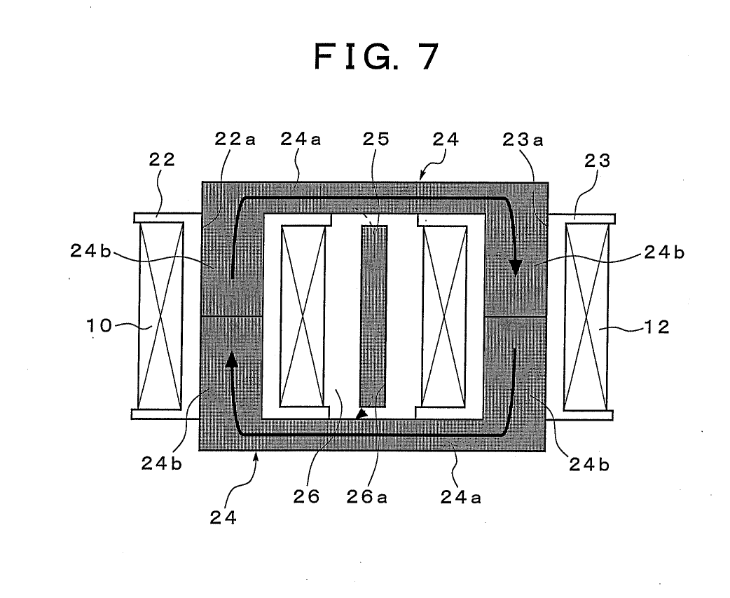

For example, FIG. 6A and FIG. 6B illustrate a modification of the first embodiment. In this transformer, the primary coil 10 and the secondary coil 12 are obtained by winding around an integrally formed bobbin 18. Namely, the bobbin 18 is formed to be substantially toric as a whole. The primary coil 10 is obtained by winding around a winding part 18a on one end part side in the axis line direction and the secondary coil 12 is obtained by winding around a winding part 18b which is on the other end part side and is formed to be spaced from the winding part 18a in the axis line direction.

By doing so, a spacing part 19 is formed between both winding parts 18a and 18b. Opening parts 20 which communicate with the spacing part 19 are formed in respective two portions of the outer circumference of the bobbin 18. A pair of legs 21a of a magnetic plate 21 which is formed into a U-shape are inserted through the opening parts 20 between the center leg 14a and the outer legs 14b of the E-shaped core 14 which are spaced therefrom.

Adopting such a configuration attains the action and effect similar to the first embodiment, and in addition to this, attains an effect that assembling is readily performed.

### Second Embodiment

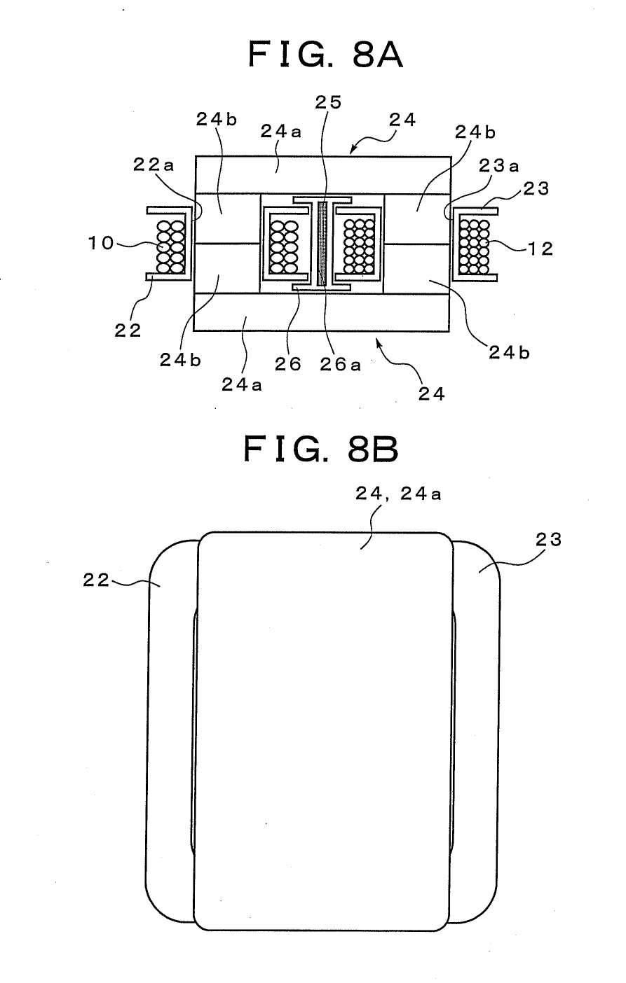

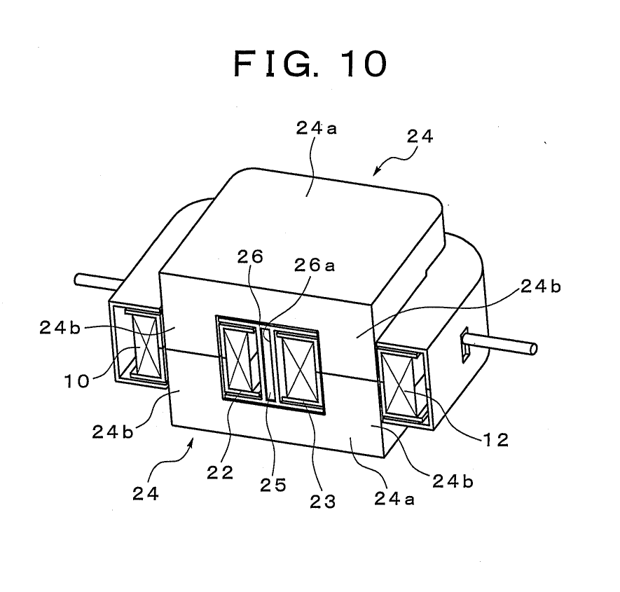

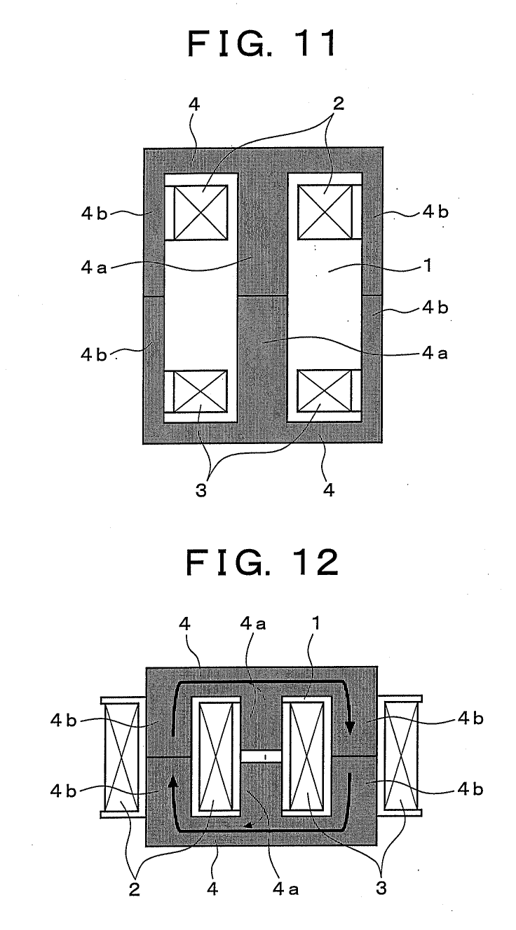

FIG. 7 to FIG. 10 illustrate a second embodiment of the transformer according to the present invention.

In this transformer, a bobbin 22 on which the primary coil 10 is obtained by winding and a bobbin 23 on which the secondary coil 12 is obtained by winding are arranged in the state where the axis lines of them are parallel to each other and a spacing is formed between the outer circumferences of them. Herein, each of winding parts of the bobbins 22 and 23 is formed into a thin and long cylindrical shape in a cross-section perpendicular to the axis line and both end parts thereof are formed into arc-shapes. By doing so, long holes 22a and 23a both end parts of which are arc-shaped are formed in the center parts of the bobbins 22 and 23.

A core for forming a rectangle-shaped primary closed magnetic circuit represented by the solid arrows in FIG. 7 is arranged across the primary coil 10 and the secondary coil 12. The core has a pair of U-shaped ferrite cores (hereafter, referred to as U-shaped cores) 24 which are arranged opposite to each other formed into a rectangle shape. Namely, each of the U-shaped cores 24 is formed of a rectangular plate-shaped flat plate part (third core) 24a disposed on the end face side of the bobbins 22 and 23 and a pair of leg parts (first and second cores) 24b integrally disposed on both sides of the flat plate part 24a to stand thereon.

In each of the U-shaped cores 24, one leg part 24b is inserted into the long hole 22a of the bobbin 22 of the primary coil 10, the other leg part 24b is inserted into the long hole 23a of the bobbin 23 of the secondary coil 12, and tip faces of them come into contact with the corresponding counterparts to be integrally shaped.

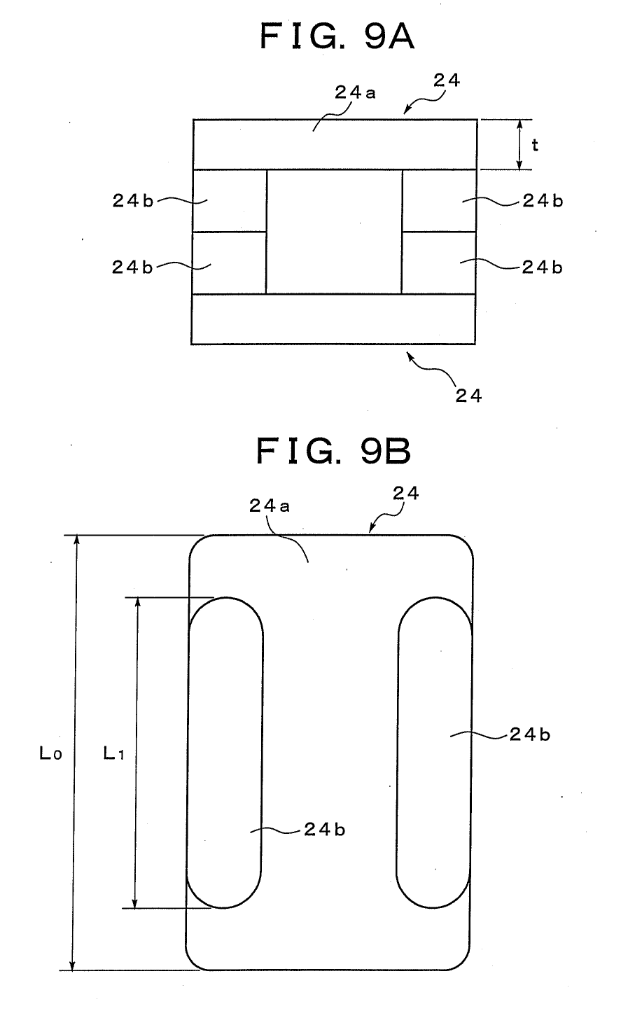

Herein, as illustrated in FIG. 9B, each of the leg parts 24b is formed into a rectangle both end parts of which are arc-shaped in cross-sectional view perpendicular to the axis line such that it can be loosely inserted into the hole part 22a, 23a of the bobbin 22, 23. The leg parts 24b are arranged such that the longitudinal directions of them are parallel to each other and are formed such that the length dimension L1 in the longitudinal direction is shorter than the length dimension L0 of the flat plate part 24a in the same direction.

A magnetic plate (magnetic body) 25 made of ferrite is attached between the axis lines of the primary coil 10 and the secondary coil 12 and between the outer circumferential parts of the primary coil 10 and the secondary coil 12. The magnetic plate 25 is formed into a rectangular flat plate shape which at least has a length not less than the length dimension L1 of the leg part 24b in the longitudinal direction. It is inserted into a slit 26a formed in an insulation member 26 which is made of synthetic plastics and fills the space between the bobbins 22 and 23.

By doing so, the magnetic plate 25 is arranged so as to make a short-cut, as represented by the dotted arrows in FIG. 7, of the annular primary closed magnetic circuit which is formed by the core and penetrates the primary coil 10 and the secondary coil 12. Moreover, the magnetic plate 25 is formed such that a cross sectional area (interlinking area) perpendicular to a direction of interlinking with its magnetic flux is smaller than a cross-sectional area (interlinking area) perpendicular to a direction of interlinking with magnetic flux of the U-shaped core 24 in the flat plate part 24a or the leg part 24b thereof.

According to the transformer of the second embodiment with the above-mentioned configuration, the magnetic plate 25 arranged between the primary coil 10 and the secondary coil 12 can make a short-cut of the rectangle-shaped primary closed magnetic circuit, of the core, which penetrates the primary coil 10 and the secondary coil 12 to form a magnetic circuit which does not penetrate the primary coil 10 or the secondary coil 12. Thereby, leakage inductance can be increased, this attaining the action and effect similar to the first embodiment.

In addition to this, since the bobbin 22 of the primary coil 10 and the bobbin 23 of the secondary coil 12 are arranged such that the axis lines of them are parallel to each other in this transformer, the transformer has a merit to be thin in thickness. Moreover, since the core which forms the primary closed magnetic circuit is formed into a rectangle shape and the magnetic plate 25 is arranged between the opposite leg parts 24b, an effect of allowing the magnetic plate 25 to have a further thinner plate shape can be attained.

Furthermore, the length dimension L0 of the flat plate part 24a in the U-shaped core 24 is larger than the length dimension L1 of the leg part 24b therein. Hence, when the cross-sectional areas, in the leg part 24b and the flat plate part 24a, in the directions perpendicular to the directions of interlinking with the magnetic flux are made equal to each other, the thickness dimension t of the flat plate part 24a can be made relatively thin, this enabling to be further thin in thickness.

### INDUSTRIAL APPLICABILITY

The present invention can be used for a transformer in which leakage inductance can be adjusted arbitrarily and which can be readily processed and be attained to be further reduced in size.

### REFERENCE SIGNS LIST

10 Primary coil

11, 13, 18, 22 and 23 Bobbins

12 Secondary coil

14 E-shaped core

14a Center leg

14b Outer leg

15, 16, 17, 21 and 25 Magnetic plates (magnetic bodies)

24 U-shaped core

24a Flat plate part (third core)

24b Leg part (first and second cores)

1. A transformer comprising:
a primary coil and a secondary coil; and
a core that forms an annular closed magnetic circuit by being arranged across the primary coil and the secondary coil, wherein
a magnetic body having a cross-sectional area smaller than a cross-sectional area of the core is arranged between the primary coil and the secondary coil so as to interpose a spacing between both of its end parts and the core and so as to make a short-cut of the annular closed magnetic circuit.

2. The transformer according to claim 1, wherein
the primary coil and the secondary coil are arranged such that axis lines of them coincide with each other, and the magnetic body is arranged between end faces of the primary coil and the secondary coil.

3. The transformer according to claim 2, wherein
the core is formed into a theta shape and includes a center leg inserted into the primary coil and the secondary coil and a pair of outer legs opposite to each other to interpose the primary coil and the secondary coil therebetween, and the magnetic body is arranged between the center leg and the outer legs.

4. The transformer according to claim 1, wherein
the primary coil and the secondary coil are arranged such that axis lines of them are parallel to each other, and the magnetic body is arranged between the axis lines and between outer circumferential parts of the primary coil and the secondary coil.

5. The transformer according to claim 4, wherein
the core is formed into a rectangle shape and includes a first core inserted into the primary coil, a second core inserted into the secondary coil and third cores which are disposed on end face sides of the primary coil and the secondary coil and join end parts of the first and second cores together, and the magnetic body is arranged between the third cores.

6. The transformer according to claim 5, wherein
the first and second cores are formed into non-columnar shapes each of which has a long-side part and a short-side part in cross-sectional view perpendicular to the axis line and are arranged such that longitudinal directions of them are parallel to each other, and the third core is formed such that its length dimension in the longitudinal direction is larger than a length dimension of the first and second cores in the relevant longitudinal direction.
